(19) United States
(12) Patent Application Publication
(10) Pub. No.: US 2020/0196594 A1
(43) Pub. Date: Jun. 25, 2020

(54) COMPOSITION AND METHOD FOR SEGREGATING EXTRACELLULAR DNA IN BLOOD

(71) Applicant: deltaDNA Biosciences Inc., Toronto (CA)

(72) Inventors: Hyman Chaim Birnboim, Toronto (CA); Michelle Bamji-Mirza, Ottawa (CA)

(73) Assignee: deltaDNA Biosciences Inc., Toronto (CA)

(21) Appl. No.: 16/726,103

(22) Filed: Dec. 23, 2019

Related U.S. Application Data
(60) Provisional application No. 62/784,592, filed on Dec. 24, 2018.

(51) Int. Cl. A01N 1/02; G01N 1/28

(52) U.S. Cl. CPC A01N 1/0231; G01N 1/28; A01N 1/0242

(57) ABSTRACT

A composition and method suitable for separating and segregating extracellular DNA in a cell-containing sample, in particular, a blood sample is described. The composition comprising a thixotropic barrier gel and a stabilizing agent in aqueous solution at a concentration of at least 400 mM is capable of establishing and maintaining separation between intracellular and extracellular DNA in blood over time by means of physical barrier wherein when the composition is mixed with whole blood and centrifuged, plasma is separated from the packed cell layer by the thixotropic barrier gel and the blood cells are separated away from the plasma.

### CROSS-REFERENCE TO RELATED APPLICATIONS

This application claims priority to U.S. provisional patent application U.S. 62/784,592 filed 24 Dec. 2018, which is hereby incorporated by reference herein in its entirety.

### FIELD OF THE INVENTION

The present invention pertains to methods and compositions suitable for stabilizing extracellular DNA in a cell-containing sample, in particular, a blood sample. In particular, a method and composition is provided for maintaining a separation between extracellular DNA and intracellular DNA in blood for extended periods of time at ambient temperature.

### BACKGROUND

Blood contains a very large number of circulating cells, only a fraction of which (white blood cells) contain intracellular DNA. In addition, very small amounts of DNA are found in the plasma, the extracellular liquid component of blood. In blood (and other bodily fluids) from normal and diseased individuals, there exists tiny amounts of extracellular DNA, which is also referred to as “cell-free DNA” (cf DNA) or “cell-free fetal DNA” (cffDNA)” or “circulating tumor DNA” (ctDNA) or “liquid biopsy”. In cases of pregnancy, this extracellular DNA derives from cells from the developing fetus that have entered the maternal circulation; in the case of malignancy, the extracellular DNA can originate from circulating lysed cancer cells. In the case of pregnancy, by analysing this DNA considerable genetic information about the developing fetus can be obtained, often as early as 8-10 weeks in pregnancy. In particular, extracellular DNA from the fetus circulating in maternal blood can be used to identify its sex, to diagnose chromosomal abnormalities, and to monitor pregnancy-associated complications. In cases of malignancy or disease, early detection of recurrence after therapy is possible. In particular, the presence of certain extracellular DNA in many medical conditions, malignancies, and infectious disease is of interest for screening, diagnosis, prognosis, surveillance for disease progression, identifying potential therapeutic targets, and for monitoring treatment response. Analysis of extracellular DNA can also provide information on the presence and concentration of said extracellular DNA derived from cells from damaged or diseased tissues or organs.

Academic research and commercial efforts have focused on extraction, purification, stabilization and genetic analysis of the extracellular DNA present in blood for the purposes of diagnostics such as cancer diagnostics and prenatal diagnostics. Improvements in non-invasive prenatal genetic tests based on DNA from the fetus in maternal blood can lead to significant health and commercial benefits. One principal benefit of cffDNA diagnostics is that a non-invasive blood test can potentially decrease the requirement for amniocentesis, an invasive procedure that carries an approximately 1% risk of inducing abortion. Commercial tests based on circulating DNA from the fetus are currently available for detecting aneuploidy, such as trisomy of chromosome 21, which causes Down Syndrome. Rapid improvements in cancer diagnostics and testing for genetic diseases at earlier times during pregnancy will also benefit from improved technology in sample collection.

Blood contains about 30-60 μg DNA/mL. The amount of extracellular DNA is typically very tiny (<20 ng/mL). Therefore, any “artifactual” contamination by intracellular DNA derived from circulating white blood cells as a result of mishandling of blood samples can make an analysis of the extracellular DNA more difficult. In the case of samples from pregnant women, fetal DNA typically comprises <10% of the total (maternal+fetal) extracellular DNA, although sometimes it can be as high as 30%. If an anticoagulated blood sample is held at room temperature more than 1-2 days, intracellular DNA is released from white blood cells because of apoptosis or necrosis and the fetal DNA becomes increasingly more dilute, making genetic analysis more difficult. In particular, even a small contamination of maternal DNA in the final nucleic acid sample will raise the level of background and make genetic tests of the fetus more difficult and complex. Maintaining the highest possible proportion of DNA from the fetus and lowest possible amount of DNA from lysing somatic cells is a highly desirable feature of any collection and purification system.

Different strategies are used to maintain the separation between extracellular DNA and intracellular DNA in freshly collected blood samples. In one method in common use for collecting blood samples for the recovery of extracellular DNA, a freshly collected blood sample is collected in an evacuated tube with a pierceable rubber stopper, such as a BD Vacutainer tube, containing an anticoagulant such as EDTA in dry form. Once a full tube of blood is introduced and the DNA is dissolved, the final concentration of EDTA is approximately 5 mM. Higher concentrations of EDTA are generally avoided because they can interfere with analysis of plasma analytes such as calcium, magnesium and other di- and trivalent metal ions. The liquid phase of blood, i.e., the plasma, is then separated from the cellular phase containing red and white blood cells by low-speed centrifugation to remove all cells as soon as possible after collection of the blood sample. Centrifuging such blood samples causes white blood cells to collect as a layer between the plasma and the red blood cells. This layer of white blood cells is called the “buffy coat” and consists of nucleated cells. To recover the plasma, which contains the extracellular DNA of interest, the plasma must be very carefully removed by aspiration so as to avoid contaminating it with any of the white blood cells in the buffy coat. Any white blood cells aspirated accidentally into the plasma may lyse as a result of the handling and release their intracellular DNA. Once the plasma is removed, any of a variety of methods can be used to purify and concentrate the extracellular DNA that is contained therein. Although effective in recovering extracellular DNA, this method requires near immediate centrifugation to remove plasma and therefore limits the point of collection to a location close to a laboratory where the plasma can be removed and stored frozen or processed immediately. With time during storage and transportation of blood within a blood tube, white blood cells spontaneously lyse, releasing intracellular materials such as DNA, thereby contaminating the plasma with intracellular DNA, in particular, genomic DNA. This process is further accelerated at ambient or elevated temperatures.

Several blood collection tubes designed for cell free DNA are commercially available from different manufacturers. Examples of manufacturers and tubes are Streck™ (cfDNA BCT), Roche Diagnostics (Cell-Free DNA Collection Tube), and Qiagen™ (PAXgene™ Blood ccfDNA Tube). In all cases, venous blood is collected directly into tubes containing a stabilizer or preservative; each manufacturer uses a different stabilizer to stabilize nucleated blood cells in blood and slow down the process of cellular DNA release into plasma. After the contents of the tube are mixed with the stabilizer, the tube is stored at room temperature until plasma is prepared and DNA is extracted. A number of recent studies have compared these tubes to one another and to plasma collected in EDTA tubes without a preservative. It has been found that these blood tubes (i.e., without a thixotropic gel) have limitations; the period of time that the samples stored in these tubes at room temperature remain stable is limited to approximately one week, after which performance deteriorates.

WO2017201612 provides an example of a differential precipitation method for preserving cell free DNA without the use of the thixotropic gel. It employs the principle initially described by Lis and Schleif (Nucleic Acids Research, 2: 383-389, 1975). These authors teach that exposing DNA to a combination of polyethylene glycol and sodium chloride at different concentrations can differentially precipitate different size classes of DNA. Thus, very high molecular weight DNA that is released from cells by high concentrations of sodium chloride are immediately precipitated by the presence of polyethylene glycol. Cell free DNA, which has a much lower molecular weight, is not precipitated under these conditions, allowing these two size classes of DNA to be separated.

Tubes designed for collecting plasma contain a special gel that creates a barrier between blood cells and plasma after centrifugation. In particular, a thixotropic gel material is disposed in the container which has a specific gravity intermediate between the specific gravities of the heavier (blood cells) and lighter (plasma) phases. During centrifugation, the thixotropic gel used in these tubes lodges between the lower packed blood cells and the upper plasma layer. The position of the gel after centrifugation is influenced by many characteristics of the gel, such as its specific gravity, yield stress and viscosity. It can also be affected by temperature, centrifugation speed, acceleration and deceleration, storage. It is also affected by factors related to the blood collected, such as heparin therapy, low hematocrit, elevated plasma protein, high lipid content and other factors that influence plasma specific gravity. The type of polymer which is used to construct the gel can also affect its viscosity, density, and other physical properties.

U.S. Pat. No. 4,816,168 to Carrol et al. describes a method for separation of mononuclear cells (lymphocytes and monocytes) from granulocytes and erythrocytes in a whole blood sample using a thixotropic gel-like substance while maintaining viability of the mononuclear cells. This was intended to be an improvement upon the method described in U.S. Pat. No. 4,190,535 to Luderer et al., which in turn was intended to be an improvement upon conventional buoyant density centrifugation utilizing Ficoll-Paque®, a liquid having a density of 1.077 g/cc. Luderer et al. describe the use of a thixotropic gel-like material having a density between 1.065-1.077 g/cc capable of separating mononuclear cells from granulocytes and erythrocytes following centrifugation. The limitation in this method identified by Carrol et al. is that granulocytes in blood appear to swell with time at ambient temperature, leading to a lowering of their buoyant density. Since separation between mononuclear cells and granulocytes is based upon buoyant density, the swollen, less dense granulocytes develop a similar density to the mononuclear cell layer, interfering with their separation, a highly undesirable feature. Carrol et al. show that freshly drawn blood, treated as described by Luderer et al., produces quantitative recovery of mononuclear cells at purities of 85% or higher. However, on storage at ambient temperature for 1-2 hours following the blood draw, the recovered mononuclear cell layer after centrifugation becomes significantly contaminated with granulocytes. Carrol et al. seeks to prevent this undesirable effect and teaches that the density of the thixotropic gel can affect the yield of cells, from a low of 15-20% (gel density=1.055 g/cc) to a high of 70-80% (gel density=1.08 g/cc), where higher yield inevitably results in lower purity. Given the desire of Carrol et al. to improve purity of the mononuclear cells, Carrol et al. generally teaches that diluting anticoagulated blood with a diluent, in a ratio of 3:1 by volume, can improve the purity without describing the affect on yield. It is suggested that the diluent prevents or reverses swelling of granulocytes, which in turn raises their buoyant density away from the buoyant density of mononuclear cells, thereby increasing the purity of the latter. Several diluents (having a requirement for being essentially chemically compatible with blood cells) are described in general detail, including: a hypertonic sodium chloride solution; iso- or hypertonic solutions of metrizamide, an iodinated organic compounds having a lipophilic substituent; or a mammalian cell culture medium. Carrol et al. also teaches that gels with a range of densities (1.063-1.075 g/cc) in combination with a diluent maintain the percentage of mononuclear cells above the gel barrier for periods up to 24 hours. However, there is no disclosure in Carrol et al. of the nature or concentration of chemicals that will free plasma from essentially all blood cells, particularly since Carrol et al. is directed to isolation and separation of mononuclear cells from other cell types.

Becton Dickinson subsequently released a commercial product to separate mononuclear cells from other white blood cells and red blood cells (BD Vacutainer® CPT™ Mononuclear Cell Preparation Tube—Sodium Citrate). The product differs appreciably from Carrol et al. in that it contains an isotonic concentration of an anticoagulant (sodium citrate or sodium heparin) located above a polyester gel. Below the gel is a known dense mixture of a synthetic saccharide and sodium diatrizoate (Ficoll™ Hypaque™). The latter is routinely used to separate mononuclear cells without the use of a barrier gel.

There remains a need for a composition, device, and method for establishing and maintaining over time separation and segregation of intracellular and extracellular DNA in blood and for prevention of contamination of extracellular DNA in extracted blood products. In particular, there is a need for a composition that prevents cellular DNA release into plasma but still permits recovery of extracellular DNA from the plasma fraction in blood.

This background information is provided for the purpose of making known information believed by the applicant to be of possible relevance to the present invention. No admission is necessarily intended, nor should be construed, that any of the preceding information constitutes prior art against the present invention.

### SUMMARY OF THE INVENTION

An object of the present invention is to provide a device, method, and compositions suitable for stabilizing extracellular DNA in a cell-containing sample, in particular, a blood sample. In particular, a method and composition is provided for segregating extracellular DNA separate from intracellular DNA in blood.

In an aspect there is provided a composition for segregating extracellular DNA in blood, the composition comprising: a thixotropic barrier gel; and a stabilizing agent in aqueous solution at a concentration of at least 400 mM, wherein the stabilizing agent in aqueous solution is in a ratio of 1 part stabilizing agent in aqueous solution to at least 6 parts blood, by volume, and wherein when the composition is mixed with whole blood and centrifuged, plasma is separated from the packed cell layer by the thixotropic barrier gel and the blood cells are separated away from the plasma.

In an embodiment of the composition, the stabilizing agent is a polyol.

In another embodiment of the composition, the polyol is sucrose, lactose, trehalose, melibiose, mannitol, inositol, or a combination thereof.

In another embodiment of the composition, the stabilizing agent is an ionic stabilizing agent.

In another embodiment of the composition, the ionic stabilizing agent is selected from a potassium salt of EDTA, a potassium salt of CDTA, a sodium salt of EDTA, a sodium salt of CDTA, sodium citrate, sodium chloride, and potassium chloride, and/or a combination thereof.

In another embodiment of the composition, the aqueous solution has a pH of between 4.0 and 10.0.

In another embodiment, the density of the thixotropic barrier gel is between about 1.045 and 1.060.

In another embodiment, the concentration of stabilizing agent in the aqueous solution is from about 400 mM to 2000 mM.

In another embodiment, the molecular weight of the stabilizing agent is less than 500.

In another aspect there is provided a use of a composition for segregating blood cells from plasma and isolating extracellular DNA in blood, the composition comprising a thixotropic barrier gel, an aqueous fluid, and a stabilizing agent at a concentration of at least 400 mM in the aqueous fluid.

In another embodiment, when mixed with blood the volume of the composition used is less than 14.3% of the total volume of combined blood and composition.

In another aspect there is provided a device for segregating extracellular DNA in blood, the device comprising: a centrifuge tube having a composition comprising: a thixotropic barrier gel; and a stabilizing agent in aqueous solution at a concentration of at least 400 mM, wherein the stabilizing agent in aqueous solution is in a ratio of 1 part stabilizing agent in aqueous solution to at least 6 parts blood, by volume, and wherein when the composition is mixed with whole blood and centrifuged, plasma is separated from the packed cell layer by the thixotropic barrier gel and the blood cells are separated away from the plasma

In another aspect there is provided a method for segregating extracellular DNA in blood, the method comprising: combining blood with a composition comprising a thixotropic barrier gel and a stabilizing agent in aqueous solution at a concentration of at least 400 mM, the stabilizing agent in aqueous solution in a ratio of 1 part to at least 6 parts of the volume of blood; centrifuging the blood into a plasma layer, a gel layer, and a cellular layer; and isolating the extracellular DNA from the plasma layer.

In an embodiment, the method further comprises storing the centrifuged blood for more than 1 day at ambient temperature prior to isolating the extracellular DNA from the plasma layer.

In an embodiment, the method further comprises storing the centrifuged blood for more than 1 week at ambient temperature prior to isolating the extracellular DNA from the plasma layer.

In an embodiment, the method further comprises storing the centrifuged blood for more than 2 weeks at ambient temperature prior to isolating the extracellular DNA from the plasma layer.

In an embodiment, the method further comprises storing the centrifuged blood for more than 3 weeks at ambient temperature prior to isolating the extracellular DNA from the plasma layer.

In another embodiment of the method, the blood and composition are mixed and centrifuged within 4 hours of the time of collection.

In another embodiment of the method, the blood and the composition are mixed, maintained at a temperature of between 0° C. and 10° C., and wherein the blood is centrifuged within 5 days of the time of collection.

In an embodiment of the method, the plasma layer is substantially free of cells.

### BRIEF DESCRIPTION OF THE FIGURES

For a better understanding of the present invention, as well as other aspects and further features thereof, reference is made to the following description which is to be used in conjunction with the accompanying drawings, where:

FIG. 1A graphically depicts the amount of extracellular total DNA after 21 days;

FIG. 1B graphically depict the amount of extracellular fetal DNA after 21 days;

FIG. 2A graphically depicts the amount of total DNA in a plasma blood fraction of a sample treated with two different stabilizing agents over 21 days;

FIG. 2B graphically depicts the amount of fetal DNA in a plasma blood fraction of a sample treated with two different stabilizing agents over 21 days;

FIG. 3 graphically depicts the amount of total extracellular DNA in plasma prepared from blood from a single donor;

FIGS. 4A and 4B graphically depict the amount of extracellular total DNA and fetal DNA, respectively, in plasma prepared from blood from a pregnant donor;

FIG. 5 graphically depicts the amount of total DNA in a plasma blood fraction of a single sample treated with two stabilizing agents, alone or in combination, over 21 days;

FIG. 6 graphically depicts the amount of total DNA in a plasma blood fraction of a sample treated with a stabilizing agent after 21 days;

FIG. 7 graphically depicts the amount of total DNA in a plasma blood fraction of a sample treated with a stabilizing agent after 7 days;

FIG. 8 graphically depicts the amount of total DNA in a plasma blood fraction of samples treated with one of three different stabilizing agents after 7 days;

FIGS. 9A and 9B graphically depicts the amount of extracellular total DNA (9A) and fetal DNA (9B) in plasma prepared from blood from a pregnant donor;

FIGS. 10A, 10B, 10C, and 10D graphically depict the amount of extracellular total DNA in plasma prepared from blood from 4 donors;

FIG. 11 graphically depicts the amount of extracellular total DNA in plasma prepared from blood from one donors treated with three different stabilizing agents; and

FIG. 12 graphically depicts the amount of extracellular total DNA in plasma prepared from blood from one donor treated with one of two different stabilizing agents and held at 0° C., 4° C. or 10° C. for 5 days prior to centrifugation.

### DETAILED DESCRIPTION OF THE INVENTION

Unless defined otherwise, all technical and scientific terms used herein have the same meaning as commonly understood by one of ordinary skill in the art to which this invention belongs.

As used in the specification and claims, the singular forms “a”, “an” and “the” include plural references unless the context clearly dictates otherwise.

The term “comprising” as used herein will be understood to mean that the list following is non-exhaustive and may or may not include any other additional suitable items, for example one or more further feature(s), component(s), ingredient(s) and/or element(s) as appropriate.

As used herein, the term “thixotropic gel” refers to a gel-like substance that is thick or viscous under static conditions but will flow and become less viscous when shaken, agitated, sheared or otherwise stressed. The function of the barrier gel is to keep the dense solution separate from the anticoagulant solution and the blood until the tube is centrifuged. Components of the thixotropic gel may include, for example, polyesters, denatured collagens, polypropylenes, polysiloxanes such as dimethylpolysiloxane and ethyltriethoxysilane, and hydrocarbon gel-like materials such as polybutene, and combinations thereof. The thixotropic gel, also referred to herein as a barrier gel, has a density in the approximate range of 1.045 to 1.060, and is chemically inert to blood constituents. The thixotropic gel also has a thixotropic index greater than 1 and up to 10, and exhibits sufficient viscosity such that at centrifugal forces below 1800 g it will flow and form the desired barrier between the plasma and blood cells.

As used herein, the term “polyol” refers to a hydrocarbon compound having more than one hydroxyl alcohol group, such as, for example, carbohydrates. Polyols particularly useful in the present invention include sugars, particularly disaccharide sugars.

Herein is described device, composition, and method suitable for stabilizing extracellular DNA in a cell-containing sample, in particular, a blood sample. In particular, a method and composition is provided for separating and segregating extracellular DNA from intracellular DNA in blood, and for a prolonged period of time. The presently described invention is capable of establishing and maintaining separation between intracellular and extracellular DNA in blood over time by means of physical barrier; this results in a delay or prevention of contamination of extracellular DNA by intracellular DNA released from lysed cells in extracted blood products. In particular, the composition is capable of separating and segregating intracellular DNA that may be released from whole cells over a prolonged period of time while still permitting facile recovery of extracellular DNA from the plasma fraction in blood. It has been found that a solution of concentrated stabilizing agent at or above 0.4 M in combination with a thixotropic barrier gel can be added to blood and held for several minutes before mixing while still maintaining the integrity of the membrane of nucleated blood cells sufficiently such that intracellular DNA does not leak from cells. By mixing such a composition at not more than 0.15 volumes of concentrated solution to 1 volume of whole blood, blood can be treated without damage to the integrity of the membrane of blood cells to segregate extracellular cfDNA. Once a blood tube containing a thixotropic gel, stabilizing agent and blood is centrifuged, the extracellular nucleic acids are protected from contamination by cellular genomic DNA (gDNA) because the cells are separated by a physical barrier that is interposed between the cell free plasma and the packed cell layer. Furthermore, by separating cells from plasma, nucleases released as a result of cell lysis will have only limited access to cell-free nucleic acids in the plasma.

The present invention approaches the problem of stabilization of extracellular DNA differently than other of blood collection tubes for cell free DNA. In particular, the presently described composition takes advantage of the fact that blood collection tubes containing a thixotropic separator/barrier gel are commonly used in clinical practice and are familiar to phlebotomists. For clinical purposes, the presence of a barrier gel in a blood collection tube is used to simplify the recovery of plasma or serum from the cellular components or clotted blood, allowing measurement of analytes such as glucose, electrolytes etc. Simplifying the workflow in a clinical testing lab is very important because of the large number of tubes that are routinely processed. For routine clinical tests of simple analytes, contamination of plasma by small numbers of cells is of no consequence. The chemical composition of the barrier gel that separates plasma from packed cells is of consequence only insofar as it might leach materials that could interfere with routine clinical tests. Thus, the present invention requires both a barrier gel and a preserving agent to effectively eliminate all, or nearly all, cellular components from the plasma without causing damage to cell membranes that could cause leakage of nucleic acids from the cells. Since analytes (other than nucleic acids) are not being measured, the choice of preserving agent can be broad. In developing the present composition, it has surprisingly been found that very concentrated/hypertonic solutions (0.4 M to 2 M) of certain low molecular weight chemical compounds could be added to samples of blood, where mixing might be delayed for several minutes. One would anticipate that blood cells located at the interface between the concentrated solution and blood before mixing would become disrupted by the osmotic shock, leading to release of intracellular DNA into the plasma; only once the concentrated solution becomes properly mixed with plasma in the blood, the more dilute/less hypertonic solution would be expected to be compatible with cell stability. However, as will be shown in the Examples, this is not the case; very little release of intracellular DNA occurs. The significance of this observation is that standard blood tubes have a fixed volume and it is highly desirable to maximize the amount of plasma that can be recovered from a single tube. Introducing the smallest possible volume of stabilizing agent into the blood tube therefore requires it to be highly concentrated to achieve the desired final concentration.

During centrifugation, the plasma moves to the top of the tube, the cellular components move to the bottom of the tube, and the barrier gel moves to an intermediate position between the two, forming a stable physical barrier that separates the liquid portion (plasma) from the cellular portion (red and white blood cells). This works because the gel has a density that is intermediate between the density of the plasma and the packed blood cells. Once blood is introduced into the tube and the tube is centrifuged (typically at 2,000 g for 10 minutes), the thixotropic gel liquefies and moves to its isopycnic position above the cellular component and below the plasma component, thereby separating the two components. Once the gel reaches its isopycnic position and stops migrating, the gel once again becomes solid. This process is usually carried out at the point of blood collection within 1-2 hours of collection. In combination with the presently described composition comprising a barrier gel and stabilizing agent, this process separates the extracellular DNA in plasma from all blood cells, which are the source of intracellular DNA.

Recognizing that whole blood is made up from approximately 58% liquid plasma and 42% packed cells means that when blood is diluted with a stabilizing agent, it is primarily the plasma that is diluted; a small amount of the stabilizing agent may enter the cells. For simplicity, the total volume of blood will be referred to herein. However, it is understood that, upon dilution, primarily the plasma fraction of the blood will be diluted by the addition of stabilizing agent.

The present invention uses buoyant density centrifugation, also referred to as isopycnic centrifugation or equilibrium density-gradient centrifugation, to separate the cells in blood from their plasma solution by their difference in density. In particular, by combining whole blood with stabilizing agent solution and a thixotropic gel, the blood cells can be separated from plasma to keep intercellular DNA from contaminating the cfDNA in plasma. In addition, it has been found that the present compositions are capable of maintaining this separation for an extended period of time.

Without being bound by theory, it is believed that the stabilizing agent acts to eliminate cells above the barrier gel by increasing the density and the tonicity of the plasma, or a combination of the two, without causing damage to cell membranes that could result in leakage of nucleic acids into the plasma. Assuming no change in the buoyant density of cells, denser plasma will allow more dense white blood cells to float in the plasma, leading to the undesirable effect of a higher number of white blood cells above the barrier gel. To overcome this tendency, cells must be exposed to a very hypertonic/hyperosmotic medium, which will cause the cells to expel water and shrink. This causes the buoyant density of the cells to increase because intracellular proteins and nucleic acids have a much higher density (1.2 and 1.7 g/cc, respectively) than water (density of 1.00), which has been expelled from the cells. An intact cell membrane is freely permeable to water. For cell shrinkage to occur, the integrity of the cell membrane must be sufficiently preserved to be able to exclude the chemicals added to produce the hyperosmotic condition. In the equilibrium state, the intracellular and the extracellular osmotic pressures are equal. Since the cell membrane is fragile and yet a very hypertonic stabilizing agent is required, it is necessary to restrict the choice of chemicals to ones that do the least damage to the cell membrane. The thixotropic gel is not considered to be significantly affected by the hypertonic medium. Rather, the increase in buoyant density of the plasma slows the upward migration of the gel during centrifugation, allowing more time for cells to migrate downward to a position below the gel before it reaches its isopycnic position and becomes solid. Individual aspects of this scheme are well known to those skilled in the art. However, because of this complex interplay of multiple factors, the choice and concentration of chemicals used in the stabilizing agent could not be predicted and needed to be determined empirically.

The density of the thixotropic gel can be measured by preparing a series of salt solutions whose densities are carefully established using a pycnometer. Different salt solutions are added to a set of tubes containing the gel in question and then centrifuged at fairly high speed. The addition of salt solutions denser than the gel will cause the gel to rise to the top during centrifugation. Conversely, if lower density solutions are added, the gel will remain in place. The density of the thixotropic gel can thereby the estimated.

The present composition is suitable for recovery of extracellular DNA from the plasma fraction of blood because it does not, or only limitedly, precipitates extracellular DNA, thereby leaving it freely accessible in the plasma fraction. Intracellular DNA is believed to be trapped below the barrier gel, leaving the extracellular DNA free in solution and separated from the intracellular DNA. The present composition comprising a barrier gel and stabilizing agent can be introduced into a blood collection tube prior to collection, during collection, or shortly after collection. Upon mixing and centrifugation of blood with the present composition, the extracellular DNA remain soluble in the liquid phase or plasma fraction, which can be used as a source of extracellular DNA.

The present compositions inhibit release of intracellular DNA into the plasma fraction of blood, thereby minimizing contamination of extracellular DNA by intracellular DNA. Stabilizing the cellular portion of the blood using the presently described composition occurs without significantly affecting the amount of extracellular DNA. Further, once the blood sample is exposed to the presently described composition and centrifuged briefly, the separated blood sample can be stored at below ambient, at ambient, or at above ambient temperatures for a prolonged period of time without significant increase in the amount of DNA in the plasma, as a result of the intracellular DNA in the sample being stabilized from release over time. Using the present composition, extracellular DNA isolated from stabilized samples comprises significantly less contamination with intracellular DNA, in particular nuclear DNA, compared to extracellular DNA that is isolated from unstabilized samples. The present compositions for separating intracellular from extracellular DNA can therefore improve reliability of diagnostic analyses of extracellular DNA due to stabilization of concentration and integrity of the extracellular DNA in the sample. Preservation of the extracellular DNA can thus improve the accuracy of diagnostic tests and provides below ambient, ambient, and above ambient temperature storage and transportation of stable extracellular DNA samples in blood.

Blood samples are commonly collected in blood collection tubes containing EDTA to prevent clotting the blood. EDTA chelates calcium, magnesium, and other metal ions, thereby inhibiting the blood coagulation cascade. The amount of EDTA in a standard anticoagulant tube is on the order of 5 millimolar when mixed with the appropriate amount of blood for the size of the collection tube and is calculated to be only slightly greater than the amount of calcium in the blood so as to remove calcium ion from the clotting cascade. Notably, some formulations of the stabilizing agent are chelators and can therefore act as anticoagulants. By including a stabilizing agent prior to blood collection and prior to the presently described separation and centrifugation, cellular DNA is stabilized and prevented from entering the plasma portion of the blood sample. Without being bound by theory, it is hypothesized that the stabilizing agent affects any of the cell size, density, or shape, and/or affects the rate of upward migration of the barrier gel such that the vast majority of the cells are transported below the plasma layer and below the barrier gel layer after centrifugation.

Preferably, thixotropic barrier gels for use in the present composition have a specific gravity intermediate to the plasma and packed blood cell phases to be separated after treatment with the stabilizing agent and are chemically inert with respect to the blood components. Additionally, preferable thixotropic barrier gels are essentially non-flowable or semi-rigid when at rest subsequent to centrifugation to allow for reasonable travel and storage. In one example, the thixotropic gel comprises a polyester. Many types of separator gels are known in the art; they are present in commercially available blood tubes where separation of plasma and the cellular fraction of blood or where separation of serum and clotted material is desired. The usage of gel barriers has provided a large benefit in collecting, processing, and storage of the specimen in the primary tube. Separator gels are capable of providing barrier properties because of the way they respond to applied forces. After blood is drawn into the evacuated gel tube, and once centrifugation begins, the g-force applied to red blood cells forces the gel at the bottom of the tube to move upward; the gel viscosity also decreases, enabling it to move or flow upwards to its isopycnic position. Once the gel reaches its isopycnic position and movement ceases, the gel becomes an immobile barrier between the supernatant and the cells. When first introduced, separator tubes contained a silicone gel, but these were unstable after sterilization. Gels are generally comprised of more than one component. They may consist of a primary organic phase, referred to as a resin, an inorganic powder, and a network stabilizing agent. The inorganic phase is needed to adjust the density of the gel so that it is between the density of the serum or plasma and the cells. To render the organic and inorganic phases compatible, a chemical stabilizing agent must be added as another component to the gel. Due to the composite nature of gels, the shelf life of gel tubes is finite. One major manufacturer of a thixotropic gel is Nippon Paint (USA) Inc., which makes the product PS Gel®. This product is described as an acrylic polymer and a suppressed filler that is thixotropic and water insoluble and retains gel-like properties.

Lin et al (Laboratory Medicine vol. 32, page 588, 2001) describe the movement of cells and the gel barrier during centrifugation in blood collection tubes. In a Becton Dickinson PST tube for separating plasma from cells, the gel moves to the interface of plasma and cells shortly after centrifugation begins. The gel moves through the blood in discrete portions until it reaches the interface. This results in fast barrier formation but entrapment of many cells above and in the gel. Lower-density and smaller cells (platelets and some white blood cells) can remain in the plasma after centrifugation. Fatas et al. (Clinical Chemistry vol. 54, page 771, 2008) report on the density of the gel in BD PST II tubes. Using different concentrations of dextran in saline, they observed that the density of the gel was between 1.038 and 1.045.

Stabilizing agents for use in the present composition can be non-ionic or ionic. Non-ionic stabilizing agents dissolve in aqueous solution without producing ions. Non-limiting examples of non-ionic stabilizing agents include polyols, and preferable polyols are sucrose, trehalose, lactose, and melibiose, inositol and mannitol. An ionic stabilizing agent is one which forms anions and cations upon dissolution in aqueous solution. Non-limiting examples of ionic stabilizing agents include salts such as, for example, potassium chloride, sodium chloride, potassium ethylenediamine tetraacetic acid (KEDTA), and potassium cyclohexanediamine tetraacetic acid (KCDTA), sodium CDTA, sodium citrate, sodium EDTA, and sodium oxamate. Compositions may also include more than one stabilizing agent, which is a combination of more than one ionic stabilizing agent, more than one non-ionic stabilizing agent, or a combination of at least one ionic and at least one non-ionic stabilizing agent. Stabilizing agents useful in the present compositions preferably have a molecular weight of less than 500 Da. The concentration of stabilizing agent should preferably be in the range of 0.4 molar to 2 molar and should be added in an amount that is no greater than 15% of the volume of the blood. It is understood that the concentration of stabilizing agent should be compatible with functioning of the separator gel such that the separator gel retains its desired properties in the composition. The pH of the aqueous solution can be anywhere between pH 4.0 and pH 10.0, and is preferably between pH 6.5 to pH 7.0.

The present compositions do not generally damage membranes of nucleated cells such that leakage of intracellular DNA from damaged cells into the plasma fraction is prevented from occurring for a prolonged period of time. The extracellular DNA in the plasma fraction of the blood treated with the present compositions has been found to be stable at room temperature for up to 21 days or longer with little or no increase in the concentration of extracellular DNA. The ratio of volume of the cell-containing biological sample to the stabilizing solution can be, for example, between about 8:1 and 20:1. Preferably, the volume of treated blood to stabilizing solution is about 10:1. The ratio of volume of the cell-containing biological sample to the thixotropic gel can be, for example, between about 7:1 and 20:1. Preferably, the volume of treated blood to thixotropic gel is about 10:1.

In one example method for removing nucleated white blood cells from plasma in blood, four basic process steps are involved: (1) a water-insoluble, thixotropic gel-like substance that is chemically inert to blood components and exhibits a specific gravity between about 1.040-1.08 g/cc is placed into a blood collection tube; (2) a stabilizing agent in solution is introduced into the tube; (3) blood is introduced into the tube; (4) the gel-stabilizing agent-blood sample is mixed and centrifuged for a sufficient length of time to cause the gel-like substance to form a barrier between the blood cells (erythrocytes, platelets, granulocytes, lymphocytes, and monocytes) and the plasma; and, thereafter, (5) the blood cells are sequestered below the plasma.

Experimental Details

Unless otherwise specified, the following techniques were used. Using standard phlebotomy techniques, venous blood samples (approximately 25 mL) were collected from donors who provided informed consent as specified by the local research ethics board. Some of the blood donors were pregnant women known to be carrying a male fetus. Blood was collected in BD Vacutainer™ Blood Collection Tubes with K₂EDTA as an anticoagulant or Greiner Bio-One VACUETTE™ Blood Collection Tubes with K₂EDTA as an anticoagulant. Collected blood was then pooled into a single 50 mL polypropylene tube and 3.5 mL aliquots were distributed into opened 5-6 mL plasma collection tubes containing a barrier gel (either Greiner K₂EDTA Sep, #456058P, 5 mL or Intervac EDTA K2 with separating gel, # EG2602, 6 mL) from which the EDTA had been removed by rinsing with water. Stabilizing agents were added (about 9% v/v of the combined volume of blood+stabilizing agent) and the tubes were capped and mixed by inversion within 3-4 minutes of combining the blood with the stabilizing agent. Within 0.1-4 hours of collection, the tubes were centrifuged at 2000 g for 10 minutes at 22° C. in an Eppendorf model 5810R clinical centrifuge with a swinging bucket rotor.

An initial aliquot (0.35 mL) of plasma was recovered following centrifugation and other aliquots taken at the times indicated in the Examples during subsequent storage of the tube at room temperature for up to 3 weeks. Aliquots were centrifuged at 13,000 g for 5 minutes to remove any residual cells or cell fragments. Supernatants were removed and stored at −30° C. until DNA was purified and analysed.

Two types of experimental controls were used. “NG-controls” contained neither gel nor stabilizing agent. They were used to assess the benefit of the complete composition (gel plus stabilizing agent) compared to anticoagulant alone (5 mM EDTA). “Controls” contained a gel but no stabilizing agent. They were used to assess the benefit of the gel compared to gel plus stabilizing agent.

Purification of DNA

DNA was purified using a manual method to ensure high recovery. Aliquots of the plasma were mixed with guanidine hydrochloride; Proteinase K was added and samples were incubated at 60° C. for 30 minutes. Samples were then subjected to a phenol extraction procedure followed by two alcohol precipitation steps. The final pellet was dissolved in a dilute buffer solution in preparation for analysis by qPCR.

Quantitation of DNA

DNA extracted from the plasma was measured by qPCR. DNA was quantified by quantitative qPCR using a Bio-Rad CFX 96 96-well instrument. The qPCR kit was SensiFAST™ SYBR™ No-ROX Kit Cat #: Bio-98002 from Bioline (FroggaBio Inc., Toronto, Ontario, Canada). Total human DNA was quantified using primers directed at the thymidylate synthase gene (TYMS, Gene ID: 7298) located on autosome 18. Male-specific DNA was quantified using Y-chromosome specific primers directed at testis specific protein, Y-linked 1 gene (TSPY, Gene ID: 7258). Their respective primers are:

### TS143 (Forward: GCCCTCTGCCAGTTCTA; Reverse: TTCAGGCCCGTGATGT)

### TSPY1_N3 (Forward: GGGCCAATGTTGTATCCTTC; Reverse: CCATCGGTCACTTACACTTC)

Cycling conditions were 95° C. (10″)/60° C. (20″)/(72° C. (40″) for 42 cycles. Standard curves were included in each qPCR run. Data were generated using Bio-Rad CFX Manager 3.1 software. Ct values were calculated by the CFX Manager software. Quantity of DNA was estimated by referencing standard curves included in each run using highly purified male donor blood DNA that had been quantified by absorbance. Results are typically presented as nanograms per millilitre (ng/mL) plasma.

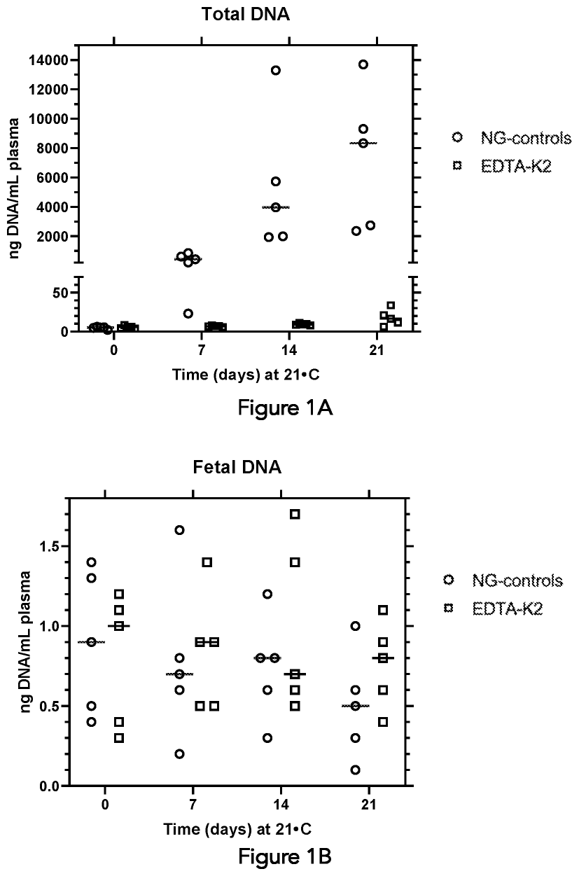

FIGS. 1A and 1B graphically depict the amount of extracellular total DNA and extracellular fetal DNA, respectively, in plasma prepared from blood from 5 pregnant donors (pD316, pD317, pD318, pD319, pD320). General experimental details are as described in the above section Experimental Details. To demonstrate the utility of the composition described herein, a comparison was made between blood samples maintained for different periods of time at 21° C. either in a tube containing no gel (NG-control) or in a tube containing the present composition (gel plus 0.1 volume of stabilizing agent to 1 volume of blood. The stabilizing agent was 0.5 M potassium EDTA at pH 6.8. The results are presented as a ‘scatter dot plot’, with the horizontal line representing the median. As also observed by numerous authors (e.g., Norton et al., J. Clin. Lab. Anal. 27:305, 2013), it is evident from these results (FIG. 1A, Total DNA) that NG (no gel) control tubes containing only the anticoagulant, 5 mM EDTA, are unable to prevent the large release (about 1000 times of the initial value) of intracellular DNA into the plasma that occurs with time. Considering that the amount of total DNA in 1 mL of blood is approximately 30,000 nanograms, a large proportion of the intracellular DNA from lysed cells has been released by day 21. In striking contrast, the amount of total DNA in blood exposed to the present composition is largely unchanged until day 14 and increased only slightly (about 3-fold) by day 21. At day 0, the amount of total DNA is equivalent in both types of tubes, i.e., containing 5 mM EDTA or the present composition. It is possible to measure DNA that is unambiguously extracellular DNA in origin in the case where the blood donors are pregnant women and fetal DNA can be detected in the plasma. The level of fetal DNA compared to total DNA acts as an internal control, since it is expected to neither increase or decrease with time in a perfectly stabilized sample. It is noted, however, that the amount of fetal DNA in fresh plasma may vary 10-fold or more from pregnant donor to donor. FIG. 1B shows that the median amount of fetal DNA did not vary appreciably in samples held at 21° C. for up to 21 days in tubes containing either 5 mM EDTA or in the present composition, indicating that the large increase in total DNA is indeed arising from maternal blood cells.

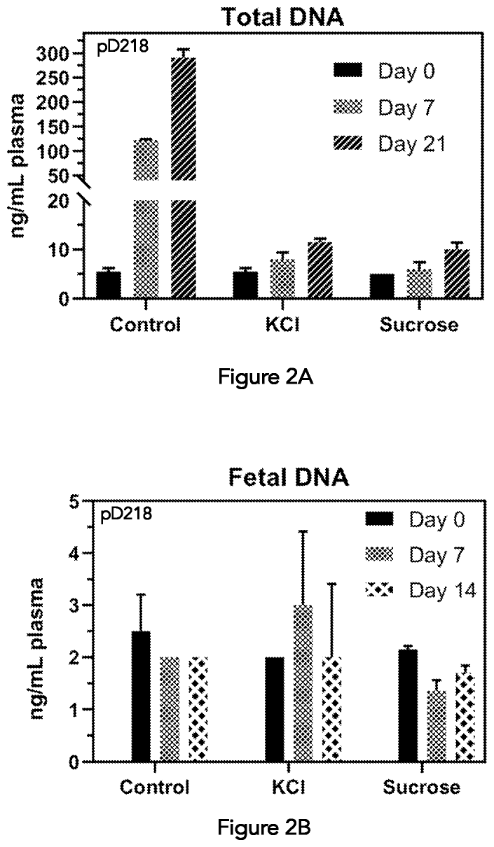

FIGS. 2A and 2B graphically depict the amount of extracellular total DNA and extracellular fetal DNA, respectively, in plasma prepared from blood from a pregnant donor (pD218). General experimental details are as described in the section Experimental Details. To demonstrate the utility of different stabilizing agents, a comparison was made between blood samples maintained for different periods of time at 21° C. either in a tube containing a gel only (Control) or in a tube containing a composition (gel plus 0.1 volume of stabilizing agent to 1 volume of blood). The stabilizing agent was either 0.9 molar potassium chloride (KCl) or 1.0 molar sucrose (Sucrose). The results are presented as a bar graph, where the error bars represent the range of 2 aliquots from the same plasma sample. Note that in Control tubes, the amount of Total DNA continued to increase with time, reaching about 20 times the initial level at day 7 and 60 times the initial level at day 21. This is far less than the approximately 1000-fold increase in the amount of total DNA in NG-control samples, indicating that the gel plays an important part in the composition. In both stabilizing agent-treated samples, the increase was less than 2 times, showing stabilization of the sample by the stabilizing agents described herein. During the same time, the amount of fetal DNA in the samples remained substantially unchanged, both in the Control samples and in the samples treated additionally with stabilizing agents. Error bars indicate the range of duplicate analyses of a single sample. These data demonstrate that the presence of a thixotropic gel alone (Control) removes a large fraction but not all the cells above the gel. In the case of tubes additionally containing a stabilizing agent, there was very little increase in DNA with time, indicating the vast majority of cells had been removed by the barrier gel. The slow release of DNA with time in both Control and test samples suggests that cells are attached to the gel surface, and that with time they undergo either lyse or apoptosis, releasing their DNA. We have direct evidence showing that slow release of DNA in Control tubes is indeed due to cells attached to the surface of the gel. At day 0, following centrifugation, all the plasma was carefully removed from Control tubes. The tubes were cut about 1 cm above the surface of the gel. The gel surface was first rinsed gently with saline, then washed vigorously with a solution containing a strong detergent, sodium dodecyl sulphate. DNA in the gently rinsed and vigorously washed fractions was analysed. It was found that there was almost no total DNA in the gently rinsed fraction but a relatively large amount of total DNA in the vigorously washed fraction. Interestingly, there was very little fetal DNA in either of these fractions, indicating the total DNA was need coming from loosely attached or gel-embedded cells.

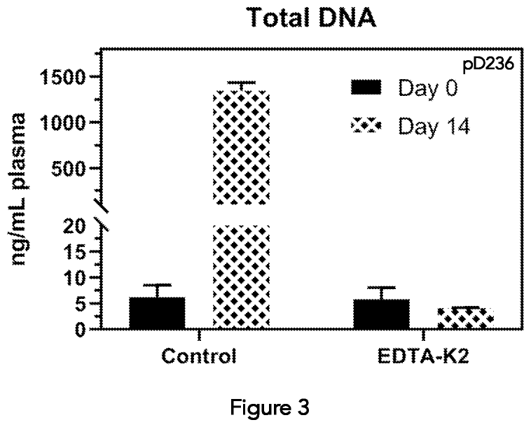

FIG. 3 graphically depicts the amount of extracellular total DNA in plasma prepared from blood from a single donor (pD236). Aliquots of the blood were distributed into blood tubes containing a thixotropic gel (Control) or tubes containing a composition (gel plus 0.1 volume of stabilizing agent to 1 volume of blood) (EDTA-K2). The stabilizing agent was 0.5 M potassium EDTA at pH 6.8. In both cases, tubes were mixed shortly before centrifugation as described in Experimental Details. Note that in the Control samples, the amount of DNA continued to increase with time, reaching over 200 times the initial level at day 14. In the stabilizing agent-treated samples, there was no discernible increase in DNA, showing stabilization of the sample by the stabilizing agents described herein. These data demonstrate that the presence of a thixotropic gel alone (Control) is insufficient to remove all the cells above the gel. In the case of tubes additionally containing a stabilizing agent, there was very little increase in DNA with time, indicating the vast majority of cells had been removed by the barrier gel.

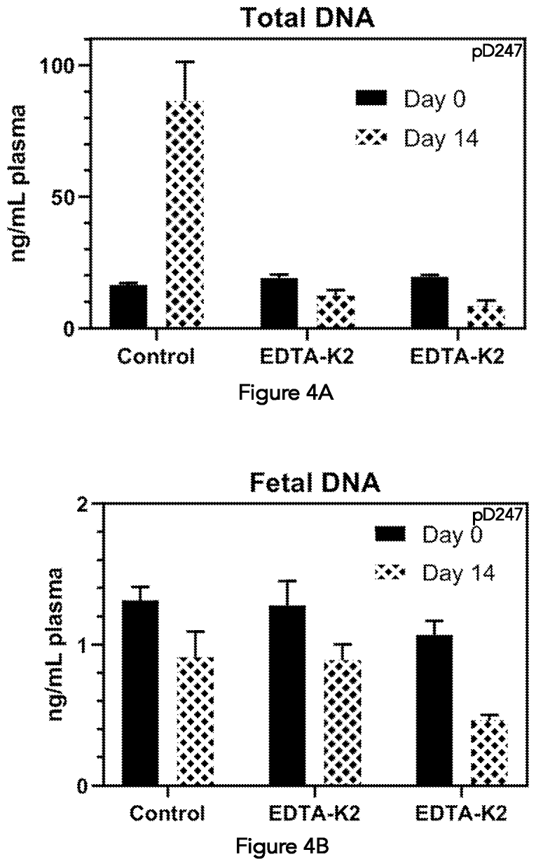

FIGS. 4A and 4B graphically depict the amount of extracellular total DNA and fetal DNA, respectively, in plasma prepared from blood from a pregnant donor (pD247). Aliquots of the blood were distributed into blood tubes containing a thixotropic gel (Control) or tubes containing a composition (gel plus 0.1 volume of stabilizing agent to 1 volume of blood) (EDTA-K2). The stabilizing agent was 0.5 M potassium EDTA at pH 6.8. The tubes were then held at ambient temperature for 14 days. Note that in Control samples the amount of total DNA continued to increase with time, reaching about 5 times the initial level by day 14. In the stabilizing agent-treated samples, there was no discernible increase in total DNA, showing stabilization of the sample by the stabilizing agents described herein. Two separate initial aliquots of blood behaved similarly. During the same time, the amount of fetal DNA in the samples decreased less than 2-fold.

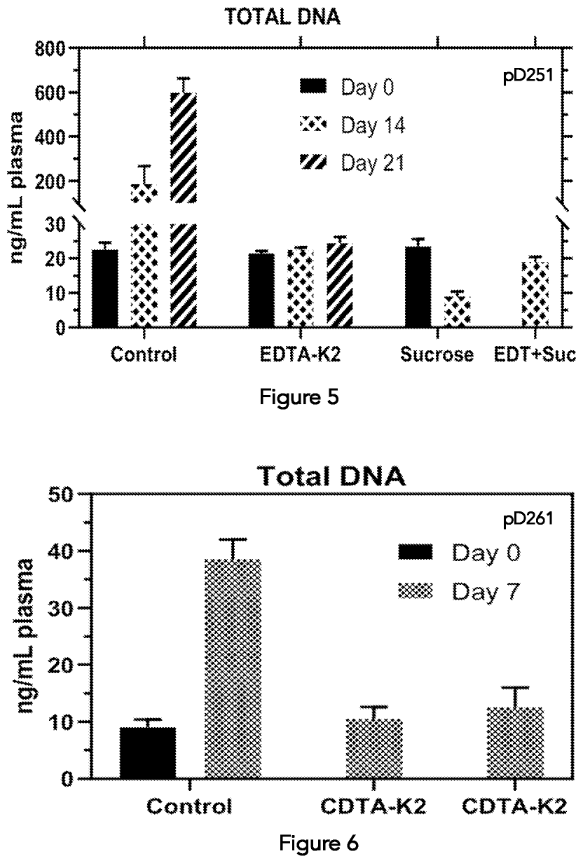

FIG. 5 graphically depicts the amount of extracellular total DNA in plasma prepared from blood from a single donor (pD251). Aliquots of the blood were distributed into blood tubes containing a thixotropic gel (Control) or tubes containing a composition (gel plus 0.1 volume of various stabilizing agents to 1 volume of blood) (EDTA-K2, Sucrose or EDT+Suc). The stabilizing agents were, respectively, in 0.5 M of potassium EDTA at pH 6.8., 1 M sucrose, or a mixture of the latter 2 chemicals in a 1:1 ratio by volume. The tubes were then held at ambient temperature for a period up to 21 days. Note that in Control samples, the amount of DNA continued to increase with time, reaching about 10 times the initial level at day 14 and 30 times the initial level at day 21. In the stabilizing agent-treated samples, there is no discernible change in the amount of cell free DNA in any of the samples. Furthermore, there is indication that a mixture of EDTA-K2 and Sucrose can be also stabilizing up to 14 days.

FIG. 6 graphically depicts the amount of extracellular total DNA in plasma prepared from blood from donor pD261. Aliquots of the blood were distributed into blood tubes containing a thixotropic gel (Control) or tubes containing a composition (gel plus 0.1 volume of stabilizing agent to 1 volume of blood) (CDTA-K2). The stabilizing agent was 0.5 M potassium CDTA (cyclohexane diamine tetraacetate) at pH 6.8. The tubes were then held at ambient temperature for 7 days. Note that, in Control samples, the amount of total DNA continued to increase with time, reaching about 4 times the initial level by day 7. In the stabilizing agent-treated samples, there was only a negligible increase in total DNA, showing stabilization of the sample by this stabilizing agent for up to 7 days. This experiment demonstrates that the potassium salt of another ionic compound can stabilize cell free DNA in plasma.

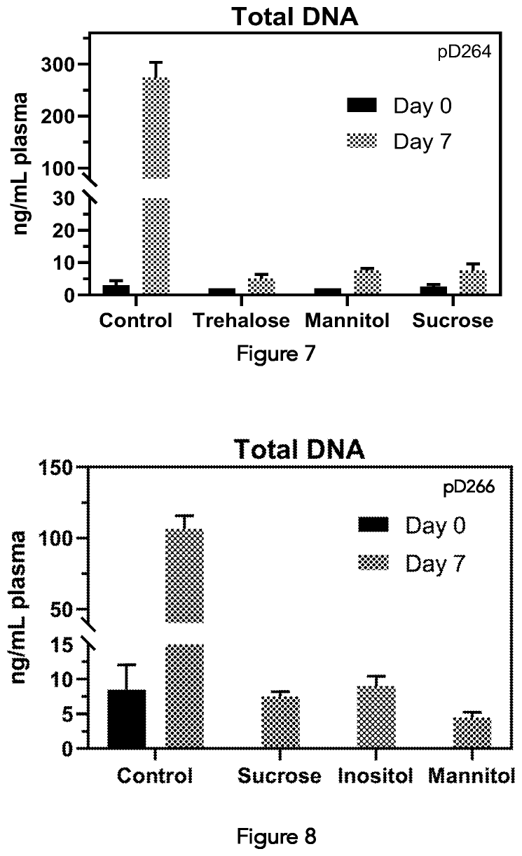

FIG. 7 graphically depicts the amount of extracellular total DNA in plasma prepared from blood from a single donor (pD264) treated with one of 3 different stabilizing agents after 7 days. Aliquots of the blood were distributed into blood tubes containing a thixotropic gel (Control) or tubes containing a composition (gel plus 0.1 volume of various stabilizing agents to 1 volume of blood) (Trehalose, Mannitol or Sucrose). The stabilizing agents were, respectively, 1.0 M trehalose, 1.0 M mannitol or 1.0 M sucrose. The tubes were then held at ambient temperature for 7 days. Note that in Control samples, the amount of DNA continued to increase with time, reaching 50-100 times the initial level at day 7. In the stabilizing agent-treated samples, there is about 2-4 times increase in the amount of cell free DNA in all of the samples. This provides evidence that low molecular weight polyols, as well as sucrose, can also be stabilizing up to 7 days.

FIG. 8 graphically depicts the amount of extracellular total DNA in plasma prepared from blood from a single donor (pD266) treated with one of 3 different stabilizing agents after 7 days. Aliquots of the blood were distributed into blood tubes containing a thixotropic gel (Control) or tubes containing a composition (gel plus 0.1 volume of various stabilizing agents to 1 volume of blood) (Sucrose, Inositol or Mannitol). The stabilizing agents were, respectively, 1.0 M sucrose, 1.0 M inositol or 1.0 M mannitol. The tubes were then held at ambient temperature for 7 days. Note that in Control samples, the amount of DNA continued to increase with time, reaching 10 times the initial level at day 7. In the stabilizing agent-treated samples, there was no increase in the amount of cell free DNA in any of the samples. This provides further evidence that low molecular weight polyols, including inositol and mannitol, can also serve as stabilizing agents up to 7 days.

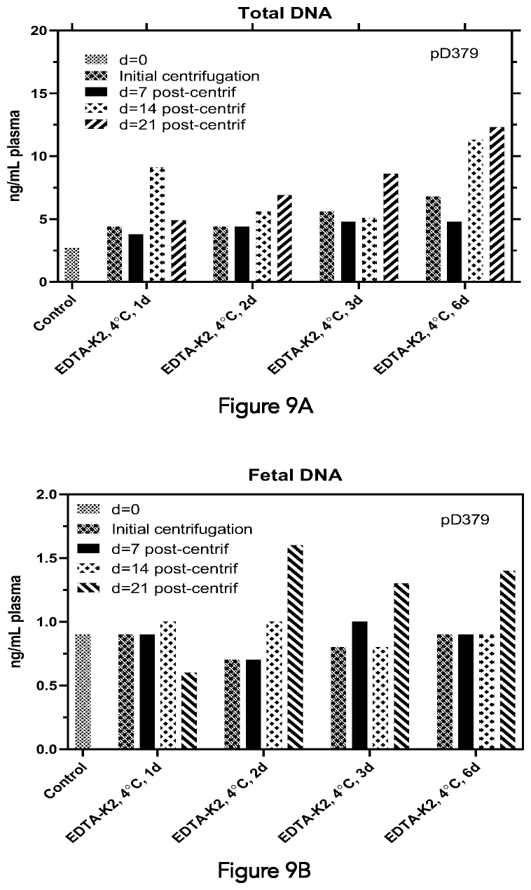

FIGS. 9A and 9B graphically depicts the amount of extracellular total DNA (9A) and fetal DNA (9B) in plasma prepared from blood from a pregnant donor (pD379) treated with a composition and held at 4° C. for 1, 2, 3 or 6 days prior to centrifugation. Aliquots of the blood were distributed into a blood tube containing no thixotropic gel (NG-control) or tubes containing a composition (gel plus 0.1 volume of a stabilizing agent to 1 volume of blood) (EDTA-K2). The stabilizing agent was 0.5 M dipotassium EDTA. The NG-control tube was centrifuged immediately to prepare cell-free plasma. The remaining tubes were then held at 4° C. temperature for 1-6 days, as indicated, then centrifuged and an aliquot of the plasma removed. Samples were then maintained at ambient temperature. At the indicated time post-centrifugation, the tubes were centrifuged and aliquots of the plasma removed. Other details are described in Experimental Details. This demonstrates that the mixing of a solution of low molecular weight (<500 Da) stabilizing agent with blood does not cause damage to the membrane of white blood cells that can result in leakage of intracellular DNA into the plasma fraction. This lack of damage is shown to be maintained for up to 6 days provided the sample is maintained at 4° C. The level of fetal DNA is essentially the same in the control and all treated samples.

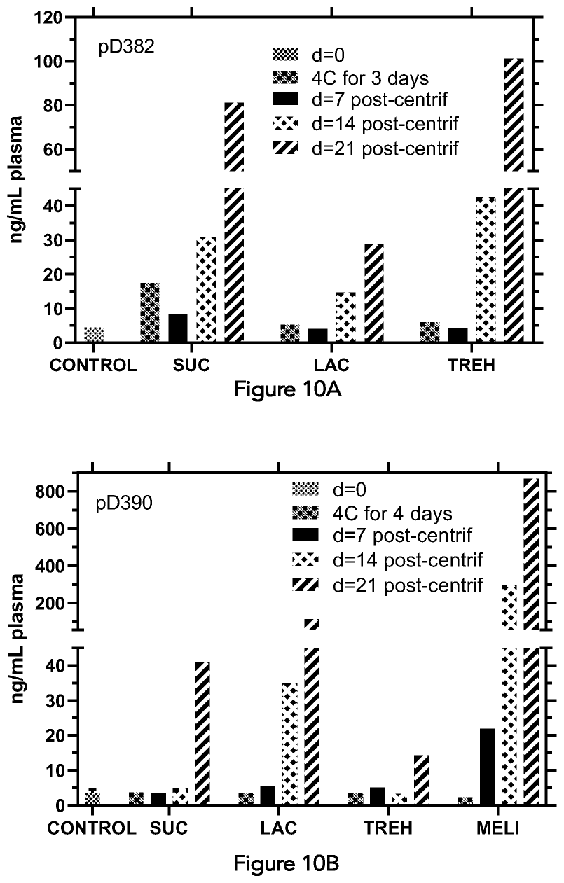

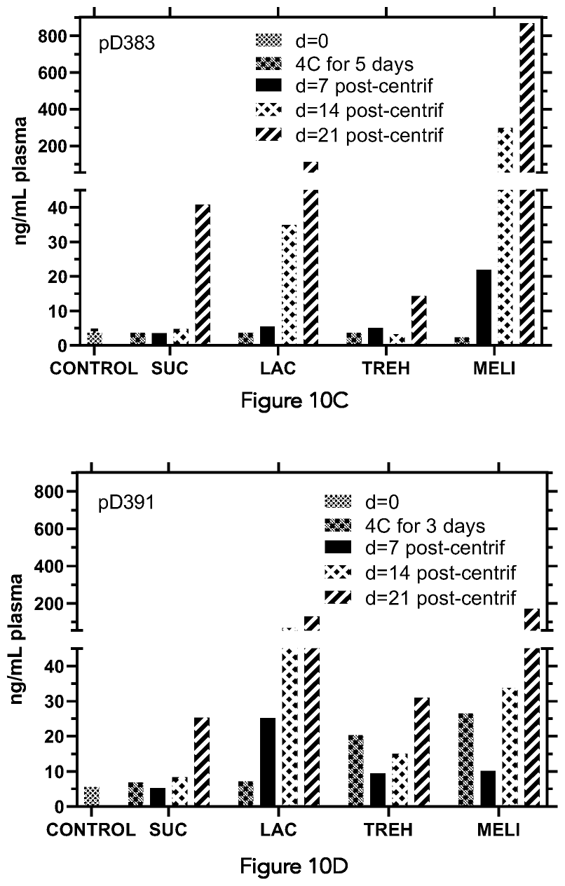

FIGS. 10A, 10B, 10C, and 10D graphically depicts the amount of extracellular total DNA in plasma prepared from blood from 4 donors (pD382, pD383, pD390 and pD391) treated with one of 4 different stabilizing agents and held at 4° C. for 3 to 5 days prior to centrifugation. Aliquots of the blood were distributed into blood tubes containing a thixotropic gel (Control) or tubes containing a composition (gel plus 0.1 volume of various concentrated stabilizing agents to 1 volume of blood) (SUC, LAC, TREH and MELD. The concentrated stabilizing agents were, respectively, 1.0 M sucrose, 1.0 M lactose, 1.0 M trehalose or 1.0 M melibiose. The Control tube was centrifuged immediately to prepare cell-free plasma. The remaining tubes were then held at 4° C. temperature for 3-5 days, as indicated. Following that, samples were maintained at ambient temperature. At the indicated time post-centrifugation, the tubes were centrifuged and aliquots of the plasma removed. Other details are described in Experimental Details. The experiments depicted in FIGS. 10A-D demonstrate that the mixing of a 1.0 M solution of low molecular weight (<500 Da) polyol with blood (at a ratio of 0.1 part concentrated solution to 1 part of blood, by volume) does not cause damage to the membrane of white blood cells that results in significant leakage of intracellular DNA into the plasma fraction. Surprisingly, this lack of damage is maintained for up to 5 days provided the sample is maintained at 4° C. However, if such samples are maintained at ambient temperatures even in the presence of stabilizing agent, extensive damage the membrane of cells occurs resulting in leakage of a large amount of intracellular DNA into the plasma fraction (data not shown). The utility of these findings is that it allows sufficient time for samples to be collected at one location and stored or transported at refrigerator temperatures to a second location where they can then be centrifuged. Furthermore, after centrifugation, the samples can be stored at ambient temperature for periods of 7-14 days with little increase in the amount of intracellular DNA in the plasma fraction.

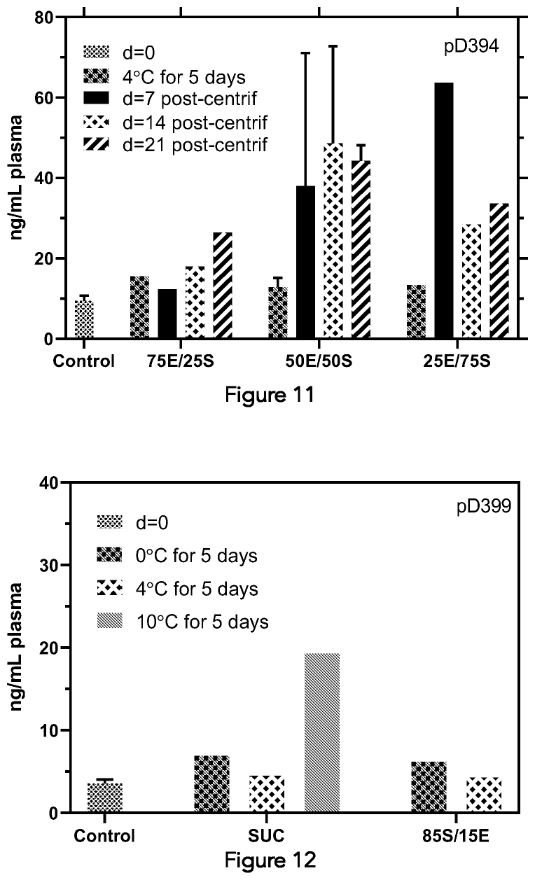

FIG. 11 graphically depicts the amount of extracellular total DNA in plasma prepared from blood from one donors (pD394) treated with one of 3 different stabilizing agents and held at 4° C. for 5 days prior to centrifugation. Aliquots of the blood were distributed into blood tubes containing a thixotropic gel (Control) or tubes containing a composition (gel plus 0.1 volume of various stabilizing agents to 1 volume of blood). The stabilizing agents were the following mixtures: 0.375 M dipotassium EDTA/0.25 M sucrose (75E/25S); 0.250 M dipotassium EDTA/0.5 M sucrose (50E/50S); 0.125 M dipotassium EDTA/0.75 M sucrose (25E/75S). The Control tube was centrifuged immediately to prepare cell-free plasma. The remaining tubes were then held at 4° C. temperature for 5 days. Following that, samples were maintained at ambient temperature. At the indicated time post-centrifugation, the tubes were centrifuged and aliquots of the plasma removed. Other details are described in Experimental Details. It is evident from the results depicted in FIG. 11 that essentially all nucleated blood cells survive the immediate shock of contact and mixing with concentrated chemicals in 3 different stabilizing agents and subsequent incubation of the plasma-diluted stabilizing agents for 5 days at 4° C., then centrifuged. Essentially no difference in the amount of released DNA in the plasma fraction of the Control (processed shortly after blood collection) and any of the 3 compositions is seen. When subsequently incubated at ambient temperature for up to 21 days post-centrifugation, some differences between the 3 stabilizing agents is seen, with 75E/25S showing greatest stability. The utility of these findings is that the composition allows sufficient time for samples to be collected at one location and stored or transported at refrigerator temperatures to a second location where they can then be centrifuged.

FIG. 12 graphically depicts the amount of extracellular total DNA in plasma prepared from blood from one donor (pD399), treated with one of two different stabilizing agents and held at 0° C., 4° C. or 10° C. for 5 days prior to centrifugation. Aliquots of the blood were distributed into blood tubes containing a thixotropic gel (Control) or tubes containing a composition (gel plus 0.1 volume of various stabilizing agents to 1 volume of blood). The stabilizing agents were 1.0 M sucrose (SUC) or a mixture containing 0.85 M sucrose and 0.075 M dipotassium EDTA (85S/15E). The Control tube was centrifuged immediately to prepare cell-free plasma. The remaining tubes were then held at 0° C., 4° C. or 10° C. for 5 days. After 5 days, the tubes were centrifuged and aliquots of the plasma removed and used to determine the amount of extracellular DNA. Other details are described in Experimental Details. It is evident from these results that essentially all nucleated blood cells survive the immediate shock of contact and mixing with concentrated chemicals in 2 different stabilizing agents for 5 days at 0° and 4° C. A small amount of leakage of intracellular DNA appears to occur at 10° C. The utility of these findings is that the composition allows sufficient time for samples to be collected at one location and stored or transported at wet ice or refrigerator temperatures to a second location where they can then be centrifuged.

All publications, patents and patent applications mentioned in this specification are indicative of the level of skill of those skilled in the art to which this invention pertains and are herein incorporated by reference. The invention being thus described, it will be obvious that the same may be varied in many ways. Such variations are not to be regarded as a departure from the scope of the invention, and all such modifications as would be obvious to one skilled in the art are intended to be included within the scope of the following claims.

We claim:

1. A composition for segregating extracellular DNA in blood comprising:
a thixotropic barrier gel; and
a stabilizing agent in aqueous solution at a concentration of at least 400 mM,
wherein the stabilizing agent in aqueous solution is in a ratio of 1 part stabilizing agent in aqueous solution to at least 6 parts blood, by volume, and
wherein when the composition is mixed with whole blood and centrifuged, plasma is separated from the packed cell layer by the thixotropic barrier gel and the blood cells are separated away from the plasma.

2. The composition of claim 1, wherein the stabilizing agent is a polyol.

3. The composition of claim 2, wherein the polyol is sucrose, lactose, trehalose, melibiose, mannitol, inositol, or a combination thereof.

4. The composition of claim 1, wherein the stabilizing agent is an ionic stabilizing agent.

5. The composition of claim 4, wherein the ionic stabilizing agent is selected from a potassium salt of EDTA, a potassium salt of CDTA, a sodium salt of EDTA, a sodium salt of CDTA, sodium citrate, sodium chloride, and potassium chloride, and a combination thereof.

6. The composition of claim 1, wherein the aqueous solution has a pH of between 4.0 and 10.0.

7. The composition of claim 1, wherein the density of the thixotropic barrier gel is between about 1.045 and 1.060.

8. The composition of claim 1, wherein the concentration of stabilizing agent in the aqueous solution is from about 400 mM to 2000 mM.

9. The composition of claim 1, wherein the molecular weight of the stabilizing agent is less than 500.

10. Use of a composition for segregating blood cells from plasma and isolating extracellular DNA in blood, the composition comprising a thixotropic barrier gel, an aqueous fluid, and a stabilizing agent at a concentration of at least 400 mM in the aqueous fluid.

11. The use of claim 10, wherein when mixed with blood the volume of the composition used is less than 14.3% of the total volume of combined blood and composition.

12. A device for segregating extracellular DNA in blood, the device comprising:
a centrifuge tube having a composition comprising:
a thixotropic barrier gel; and
a stabilizing agent in aqueous solution at a concentration of at least 400 mM,
wherein the stabilizing agent in aqueous solution is in a ratio of 1 part stabilizing agent in aqueous solution to at least 6 parts blood, by volume, and
wherein when the composition is mixed with whole blood and centrifuged, plasma is separated from the packed cell layer by the thixotropic barrier gel and the blood cells are separated away from the plasma.

13. A method for segregating extracellular DNA in blood, the method comprising:
combining blood with a composition comprising a thixotropic barrier gel and a stabilizing agent in aqueous solution at a concentration of at least 400 mM, the stabilizing agent in aqueous solution in a ratio of 1 part to at least 6 parts of the volume of blood;
centrifuging the blood into a plasma layer, a gel layer, and a cellular layer; and
isolating the extracellular DNA from the plasma layer.

14. The method of claim 13, further comprising storing the centrifuged blood for more than 1 day at ambient temperature prior to isolating the extracellular DNA from the plasma layer.

15. The method of claim 13, further comprising storing the centrifuged blood for more than 1 week at ambient temperature prior to isolating the extracellular DNA from the plasma layer.

16. The method of claim 13, further comprising storing the centrifuged blood for more than 2 weeks at ambient temperature prior to isolating the extracellular DNA from the plasma layer.

17. The method of claim 13, further comprising storing the centrifuged blood for more than 3 weeks at ambient temperature prior to isolating the extracellular DNA from the plasma layer.

18. The method of claim 13, wherein the blood and composition are mixed and centrifuged within 4 hours of the time of collection.

19. The method of claim 13, wherein the blood and the composition are mixed, maintained at a temperature of between 0° C. and 10° C., and wherein the blood is centrifuged within 5 days of the time of collection.

20. The method of claim 13, wherein the plasma layer is substantially free of cells.
